(19) United States
(12) Patent Application Publication
(10) Pub. No.: US 2008/0078068 A1
(43) Pub. Date: Apr. 3, 2008

(54) Flat Shower Track

(76) Inventor: Gregory J. Cervantes, Sherman Oaks, CA (US)

Correspondence Address: ADVANTIA LAW GROUP, 9035 SOUTH 1300 EAST, SUITE 200, SANDY, UT, 84094, US

(21) Appl. No.: 11/466,320

(22) Filed: Aug. 22, 2006

(51) Int. Cl. E05D 15/06

(52) U.S. Cl. 16/96 R

(57) ABSTRACT

A sliding shower door track for guiding and retaining one or more sliding shower doors. The track includes a column member adapted to be carried by a shower surface and includes: two grooves spanning the column member; a central ridge member spanning the column member and is disposed between the grooves; two ridge members spanning the column member and is respectively adjacent to the grooves; and retention members that substantially spans the column member and extends from the central and first side ridge members towards but not substantially in contact with the central and first side ridge members. The cross-sectional shape of the column ends is substantially trapezoidal. The column member has a plurality of water drainage ports adapted to allow the drainage of water from the track. The retention member is coupled to and extending from the central and first side ridge members.

### BACKGROUND OF THE INVENTION

1. Field of the Invention

The present invention generally bathroom shower doors, and particularly relates to further improvements in the mounting of bathroom shower doors.

2. Description of the Related Art

In the related art, it has been known that sliding shower doors permit easy ingress to and egress from bathroom showers, while protecting the rest of the bathroom from water spillage. However, the tracks used to guide and align the sliding doors are often very uncomfortable when pressed against a body. For example, prior art sliding shower door tracks tend to have relatively sharp edges that make them uncomfortable upon which to sit, and make passage over them painful to pressing body parts. It is also more awkward and uncomfortable for adults to bathe very young children in such an environment. The following are examples of related art that are provided herein for their related teachings, and are herein incorporated by reference for their supportive teachings:

U.S. Pat. No. 6,662,385, issued to Bayne, is a shower door track with cushion provided, which includes a material having a length. A slit is cut longitudinally along the length of the bottom of the material. The slit is adapted to fit over a shower door track and retain the material on the shower door track, which is located along a top edge of a bathtub. The material includes an extending rectangular section integral to the material at one end of the length of the material, which is adapted to fit between a first and a second shower door vertical support in order to retain the material between the first and second shower door vertical supports. The material can be made of polyethylene foam and can include a rounded top.

U.S. Pat. No. 4,089,135, issued to Beny, et al., discloses doors that are slideably mounted in tracks by structure which cooperates with and follows the course of the tracks even around sharp corners and curves to permit sliding of the doors into out of the way storage positions. The sliding door assembly is illustrated forming a bathtub/shower enclosure.

U.S. Pat. No. 4,611,436, issued to Williams, is a sliding door assembly for bathtubs, shower stalls and the like. The assembly includes at least one door panel, an elongated support rail member, and support mount structure for slidably mounting the door panel to the support rail member. The support mount structure includes an elongated carriage member attached to the door panel and a pair of support rollers mounted to the carriage member and engaging the support rail member. The rollers are free to move lengthwise along the carriage member as the door is open and closed. However, structure is provided to stop the lengthwise motion of the rollers just prior to the door panel reaching a closed position to brake the motion of the door panel as it is moved to the closed position.

U.S. Pat. No. 5,867,846, issued to Paredes, et al., discloses a lightweight, low cost shower door assembly for enclosing a tub or shower enclosure having sides and a base. It includes an upper support member adapted to be positioned against opposing sides of the enclosure and a lower support member adapted to be positioned against the base of the enclosure. A door in the assembly includes a flexible rod connecting first and second frame members. The first frame member is connected to the upper and lower support members and positioned for movement about a vertical axis. The flexible rod is bowed to apply an upward force on the second frame member in order to maintain it in releasable connection with the upper support member. In use, a section of replaceable fabric or vinyl extends across the frame members in order to provide a water barrier for the door.

U.S. Pat. No. 4,424,605, issued to Squires, et al., discloses a A sliding door support assembly having a preassembled track assembly including a split cylindrical elongate track having a flat surface on the top and a number of mounting brackets secured to the flat surface at spaced intervals and a number of support members for supporting an elongate track cover, the support members being mounted on said track assembly after the door has been mounted in the track assembly and being selected to correspond to a particular type of track cover.

The inventions heretofore known suffer from a number of disadvantages which include uncomfortable to sit upon when entering or exiting a shower stall, and/or complicate the process of preventing falling accidents, pain and discomfort associated using prior art sliding shower door tracks.

What is needed is a flat shower track that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved. Accordingly, the present invention has been developed to provide a sliding shower door track for guiding and retaining one or more sliding shower doors.

In one embodiment, the track may have a column member adapted to be carried by a shower surface and may include: a first groove and a second groove that may span the column member; a central ridge member that may span the column member and may be disposed between the first and second grooves; a first side ridge member and a second side ridge member that may span the column member and may be respectively adjacent to the first and second grooves; and a retention member that may substantially span the column member and may be extending from one of the central ridge member and first side ridge member towards but may not be substantially in contact with the other of the central ridge member and first side ridge member, thereby forming a substantially flat surface covering a portion of the first groove.

Additionally, the track member may have a plurality of water drainage ports adapted to allow the drainage of water from the track. The ports may be located on one side of the column member. The retention member may be coupled to and extending from both the central ridge member and first side ridge member. There may be a second retention member that may substantially span the column member and may extend from one of the central ridge member and second side ridge member towards but may not be substantially in contact with the other of the central ridge member and second side ridge member, thereby forming a substantially flat surface covering a portion of the first groove.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of a sliding door track as seen from the inside of a shower stall or converted bathtub according to one embodiment of the invention;

FIG. 2 is an end view of the a sliding door track according to one embodiment of the invention;

FIG. 3 is an isometric view of a sliding door track as seen from the inside of a shower stall or converted bathtub according to another embodiment of the invention; and

FIG. 4 is an end view of the sliding door track according to another embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

The present-inventive sliding door track eliminates the sharp edges of the prior art, with a substantially flat surface to provide more comfort for contacting body parts (e.g., thighs or knees pressed against the track while sitting or kneeling, respectively).

As shown in the figures, an embodiment of the tracks 100, 120 (also referred to as a column member) adapted to be carried by a shower surface. The column members 100 includes: first grooves 116, 122 and second grooves 124, 128, each spanning the column member; a central ridge member 129 spanning the column members 100, 120 and is disposed between the grooves 116, 122, 124, 128; a first ridge member 114 and a second ridge member 112, each spanning the column members 100, 120 and is respectively adjacent to the grooves 116, 122, 124, 128.

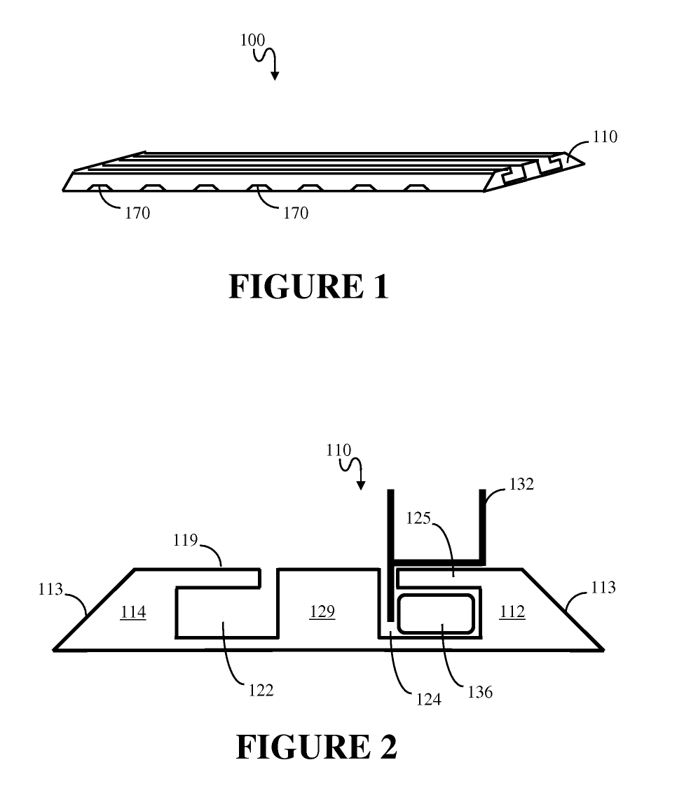

In one embodiment shown in FIGS. 1 and 2; the column member 100 may include: a first retention member 119 and a second retention member 125, each substantially spanning the column member 100 and extending from ridge members 114, 112 but not substantially in contact with the central ridge member 129, thereby forming flat surfaces covering a portion of the grooves 122, 124. The grooves 122, 124 and retention members 119, 125 cooperate to securely retain shower door frame wheels 136 that are engaged with the sides of the grooves and retention members to properly register and guide the engaged sliding shower door 132.

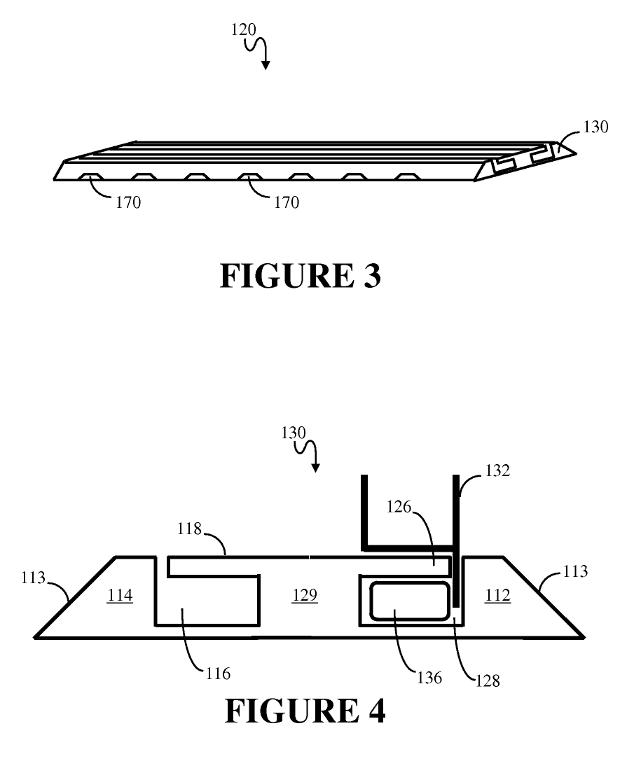

In another embodiment shown in FIGS. 3 and 4; the column member 120 includes: first retention member 118 and a second retention member 126, each substantially spanning the column member 120 and extending from the central ridge member 129, but not substantially in contact with the ridge members 114, 112, thereby forming flat surfaces covering a portion of the grooves 116, 128.

It is also noted that the column members 100, 120 has column ends 110, 130 that are substantially trapezoidal in shape. In addition, there is a plurality of water drainage ports 170 located on one side of the column members 100, 120 that is adapted to allow the drainage of water from the track. In alternative embodiments of the invention, the column ends 110, 130 may be shaped differently and the drainage ports 170 may be positioned anywhere along the side of the column members 100, 120.

It is also envisioned that the ridge members 114, 112 help maintain the movable sliding shower door frames 132 in an erect position normal to the column members 100, 120. This help prevents the door frames 132 from disengaging from the tracks and falling into the shower stall. Thus, significantly eliminating possible injuries to a user taking a shower.

In yet another embodiment, the ridge members 114, 112 has slanted edges 113 and a plurality of drainage ports 170 (located on the side toward the shower or bathtub) which extend through all grooves and provide drainage of water from the track into the shower or tub. The ridge member edges 113 and drainage ports 170 help prevent water from leaking out of the shower stall and getting on the floor in close proximity of the column members 100, 120 thus reducing the chances of a user from slipping and falling upon exiting the shower. Further, the drainage ports 170 may be positioned anywhere along the tracks 100 and 120 facing the inside of a shower stall and be at different distances from each other.

In operation according to one embodiment, one skilled in the art of installing shower doors would know that the length of the column members 100, 120 may be chosen to allow a clearance or void between the central ridge member 129 and ridge members 114, 112 so that a sliding shower door frame 132 with wheels 136 may be inserted into, and securely maneuver inside the grooves 122, 124.

In one embodiment, the tracks 100, 120 may be adapted to be located on a bathtub ledge, or at the floor of a shower stall, as with prior art tracks, although other mounting configurations are possible.

In another embodiment, the tracks 100 and 120 may be configured to have one groove per shower door to accommodate narrower width tub walls.

In yet another embodiment, the width and dimensions of the grooves 116, 122, 124 and 128 may vary depending on the size of the door frame wheels 136 and finished production of the tracks 100 and 120.

In still yet another embodiment, the grooves 116, 122, 124, 128 may run the entire length of the tracks 100 and 120 but are not limited to the entire length of the tracks.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

It is also envisioned that the column ends 110 and 130 of the end members 112 may vary from a defined trapezoid and have rounded edges for smoother finishes as to adhere to and/or fit the shape of various styles of showers stalls or bath tubs.

Finally, it is envisioned that the components of the tracks 100 and 120 may be constructed of a variety of materials, including, but not limited to metal, composite material, plastics, ceramics, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A sliding shower door track for guiding and retaining one or more sliding shower doors, the track comprising:
a column member adapted to be carried by a shower surface and including:
a first groove and a second groove, each spanning the column member;
a central ridge member spanning the column member and disposed between the first and second grooves;
a first side ridge member and a second side ridge member, each spanning the column member and respectively adjacent the first and second grooves; and
a retention member substantially spanning the column member and extending from one of the central ridge member and first side ridge member towards but not substantially in contact with the other of the central ridge member and first side ridge member, thereby forming a substantially flat surface covering a portion of the first groove.

2. The track of claim 1, wherein the cross-sectional shape of said column ends is substantially trapezoidal.

3. The track of claim 1, wherein said column member further has a plurality of water drainage ports adapted to allow the drainage of water from said track.

4. The track of claim 3, wherein said ports are located on one side of said column member.

5. The track of claim 1, wherein the retention member is coupled to and extending from the central ridge member.

6. The track of claim 1, wherein the retention member is coupled to and extending from the first side ridge member.

7. The track of claim 1, further comprising a second retention member substantially spanning the column member and extending from one of the central ridge member and second side ridge member towards but not substantially in contact with the other of the central ridge member and second side ridge member, thereby forming a substantially flat surface covering a portion of the first groove.

8. A sliding shower door track for guiding and retaining one or more sliding shower doors, the track consisting essentially of:
a column member adapted to be carried by a shower surface and including:
a first groove and a second groove, each spanning the column member;
a central ridge member spanning the column member and disposed between the first and second grooves;
a first side ridge member and a second side ridge member, each spanning the column member and respectively adjacent the first and second grooves; and
a retention member substantially spanning the column member and extending from one of the central ridge member and first side ridge member towards but not substantially in contact with the other of the central ridge member and first side ridge member, thereby forming a substantially flat surface covering a portion of the first groove.

9. The track of claim 8, wherein the cross-sectional shape of said column ends is substantially trapezoidal.

10. The track of claim 9, wherein said column member further has a plurality of water drainage ports adapted to allow the drainage of water from said track.

11. The track of claim 10, wherein said ports are located on one side of said column member.
